(19) United States
(12) Patent Application Publication
(10) Pub. No.: US 2008/0265158 A1
(43) Pub. Date: Oct. 30, 2008

(54) CHARGED PARTICLE BEAM APPARATUS

(76) Inventor: Kouji Iwasaki, Chiba-shi (JP)

Correspondence Address: BRINKS HOFER GILSON & LIONE, P.O. BOX 10395, CHICAGO, IL, 60610, US

(21) Appl. No.: 12/104,160

(22) Filed: Apr. 16, 2008

(30) Foreign Application Priority Data
Apr. 24, 2007 (JP) JP2007-114000

(51) Int. Cl. G01N 23/00

(52) U.S. Cl. 250/310

(57) ABSTRACT

A charged particle beam instrument is offered which comprises an irradiation mechanism for irradiating a sample with a charged particle beam (FIB/EB), a detection mechanism for detecting secondary charged particles produced by the irradiation by the charged particle beam, a storage portion for previously storing three-dimensional data about the irradiation mechanism and detection mechanism in an interrelated manner to the stage coordinate system W, a conversion portion for converting three-dimensional data about the sample into the stage coordinate system, and a decision portion for simulating the positional relationships among the sample, irradiation mechanism, and detection mechanism based on data converted by the conversion portion and on data stored in the storage portion when a certain position on the sample is placed into a measurement point and for previously making a decision as to whether the sample will interfere and making a report of the result of the decision.

This application claims priority under 35 U.S.C. §119 to Japanese Patent Application No. JP2007-114000 filed on Apr. 24, 2007, the entire content of which is hereby incorporated by reference.

### BACKGROUND OF THE INVENTION

The present invention relates to a charged particle beam apparatus for observing, processing, or otherwise handling a sample by irradiating it with a charged-particle beam such as a focused ion beam or electron beam.

In recent years, because of development of microlithography techniques, semiconductor devices such as integrated circuits (ICs) have been made increasingly finer. Concomitantly with this, the process for fabricating semiconductor devices has become complex, and more steps have been required. In evaluating these steps, a method utilizing a charged particle beam apparatus has been known from the past. This method of utilizing the charged particle beam apparatus is a method of observing samples such as semiconductor devices or making various evaluations or analyses by irradiating the samples with a focused ion beam (FIB) or electron beam (EB).

This charged particle beam apparatus is described briefly.

As shown in FIG. 6, the charged particle beam apparatus 40 has a sample holder 42 on which a sample 41 is placed, a stage 43 for displacing the sample 41 via the sample holder 42, an irradiation system (not shown) for irradiating the sample 41 with an FIB or EB, a detector (not shown) for detecting secondary charged particles produced by the FIB or EB irradiation, and a gas gun 44 for supplying a source gas G for depositing a film on the surface of the sample 41.

For example, the stage 43 is a five-axis stage that can move the sample holder 42 in the XYZ directions. The stage can rotate the sample holder about the Z-axis and, at the same time, rotationally tilt the holder about the X-axis or Y-axis.

Where the sample 41 is observed by utilizing this charged particle beam apparatus 40, the sample 41 is set on the sample holder 42 and then the sample 41 is irradiated with the FIB or EB by the irradiation system. At this time, secondary charged particles produced by FIB or EB irradiation are detected by the detector. The detected secondary charged particles are converted into a brightness signal or the like. Thus, a sample image can be displayed on the display portion (not shown). The sample image can be observed within a given range by appropriately moving or tilting the sample 41 via the sample holder 42 by means of the stage 43. Concomitantly, various evaluations or analyses can be performed based on the sample image.

The charged particle beam apparatus 40 permits simple observation. In addition, the apparatus can work the sample 41 so as to modify it. For example, where the sample 41 is an IC, a defective portion is checked by an observation and then the defective portion is etched by irradiation by an FIB to modify the defective portion. Alternatively, a modification can be made by depositing a film on the defective portion by a gas assisted method relying on FIB irradiation and supply of the source gas G.

In observing or processing the aforementioned sample 41, bringing a certain position on the sample 41 into a given position on the stage 43 is taken as a very important work, in order to irradiate the certain position on the sample 41 with FIB or EB or to deposit a film. However, this work is very time consuming to perform, because it is necessary to operate the stage 43 frequently. Therefore, the efficiency of this work is enhanced using a technique consisting of matching data about the coordinates of the sample 41 with data about the coordinates of the stage 43. This assists the operator.

Planar coordinate linkage is used as the aforementioned coordinate data. Therefore, in the case of the sample 41 having uneven surfaces such as an IC package or in the case of the sample 41 having a complex three-dimensional shape, when the stage 43 is operated, there is the danger that the sample 41 interferes with each component (such as irradiation system, detector, gas gun 44, and so on) as shown in FIG. 7. If such interference occurs, the components and the sample 41 are deformed or damaged. Therefore, it has been necessary for the operator to carefully operate the stage 43 with caution. For this reason, a long time is taken. In addition, heavy burden is imposed on the operator.

Especially, in order to observe or process the sample 41 at high accuracy, the components are generally placed as close as possible to the sample 41 (e.g., the space between the sample surface and each component is 0.2 mm to 0.8 mm). Consequently, the aforementioned problem tends to occur.

Accordingly, various methods are conceivable to alleviate the burden on the operator. One known method consists of adopting an interlock system for stopping the operation of the stage 43 at the instant when the sample 41 touches each component. In particular, in this method, a minute voltage is previously applied to each component. A minute current produced when each component touches the sample 41 is detected. When an electrical current is detected, operation of the stage 43 is stopped.

Another known method consists of installing a multiplicity of optical elements such as CCDs or the like around the sample 41 and making optical observations from various angles. In this way, the operator can check the positional relationship between each component and the sample 41 at many visual points when the stage 43 is operated. Consequently, interference can be prevented as much as possible.

[Patent Reference 1] JP-A-3-284826

However, in the above-described prior-art methods, the following problems remain.

That is, the method adopting the interlock system is a method for detecting an electrical current when interference occurs. Therefore, the interference itself cannot be removed. Accordingly, excessive interference can be prevented but the possibility of deformation of or damage to the sample 41 and components still remains. Furthermore, the method can be applied only to the conductive sample 41. Limitations are imposed on the usable kind of the sample 41. Hence, it has been difficult to use the method.

In addition, the method of installing a multiplicity of optical elements permits confirmation from many visual points. Yet, it is still necessary for the operator to perform manipulations with caution. Therefore, it has been impossible to alleviate the burden on the operator. Especially, in the case of the sample 41 having a complex three-dimensional shape, even if a number of optical elements are installed, dead angles are formed. Sometimes, it has been impossible to precisely grasp the positional relationship between the sample 41 and each component. Consequently, it is unlikely that interference can be prevented with certainty.

The present invention has been made, taking account of these circumstances. It is an object to offer a charged particle beam apparatus which can prevent interference with a sample by forecasting the interference before the stage is operated irrespective of the kind of the sample and which can reduce burden on the operator to a minimum.

### BRIEF SUMMARY

To solve the foregoing problem, the present invention offers the following means.

A charged particle beam apparatus associated with the present invention comprises: a sample table on which a sample is placed; a stage for displacing the sample table to place a certain position on the sample into a measurement point; an irradiation mechanism for irradiating the sample placed in the measurement point with a beam of charged particles; a detection mechanism for detecting secondary charged particles produced by the irradiation by the beam of the charged particles; a display mechanism for creating image data about the sample based on the detected secondary charged particles, the display mechanism having a display portion for displaying the image data as a sample image; a storage portion for previously storing three-dimensional data about the irradiation mechanism and the detection mechanism such that the three-dimensional data are interrelated to a stage coordinate system of the stage; a conversion portion for converting previously entered three-dimensional data about the sample into the stage coordinate system, based on posture of the placed sample and on position of the placement; and a decision portion for making a decision in advance as to whether the sample will interference and making a report of the result of the decision by simulating the positional relationships among the sample, the irradiation mechanism, and the detection mechanism based on data converted by the conversion portion and on data stored in the storage portion when the certain position on the sample is placed at the measurement point.

In the charged particle beam apparatus associated with this invention, the sample placed on the sample table is irradiated with a charged particle beam such as a focused ion beam, electron beam, or the like. At this time, the certain position on the sample to be measured can be placed at an observation point by appropriately displacing (moving or rotating) the sample table by means of the stage. It is possible that the charged particle beam is made to hit the certain position. Secondary charged particles produced by the charged particle beam irradiation are detected by the detection mechanism. The display mechanism creates image data about the sample based on the detected secondary charged particles and displays the created image data as a sample image on the display portion.

Thus, the operator can observe the certain position on the sample. Furthermore, the next certain position can be placed into the measurement point by appropriately displacing the sample table by means of the stage. The sample can be observed within a certain range.

When the aforementioned sample is observed, the operator can forecast as to whether the sample will interfere with the irradiation mechanism and the detection mechanism when the certain position on the sample is placed at the measurement point or along the route to the measurement point. Interference can be prevented.

That is, three-dimensional data about the irradiation mechanism and detection mechanism disposed over the sample are previously stored in the storage portion while being interrelated to the stage coordinate system. That is, according to the data stored in the storage portion, three-dimensional contour lines of the irradiation mechanism and detection mechanism can be precisely grasped. Furthermore, it is possible to precisely grasp the positions within the stage coordinate system at which the irradiation mechanism and detection mechanism are disposed.

Furthermore, three-dimensional data about the sample that is an object to be measured has been previously entered in the conversion portion. Consequently, it is similarly possible to precisely grasp the three-dimensional contour line of the sample how complex is the sample's shape. The conversion portion performs processing for converting the three-dimensional data about the sample into the stage coordinate system based on the posture of the sample and on the position at which the sample is placed after the sample is actually placed on the sample table. In consequence, the three-dimensional data about the sample can be linked to the stage coordinate system. The manner in which the sample is placed on the stage actually can be precisely recognized as three-dimensional data.

Consequently, the decision portion can precisely grasp the relative positional relationships among the sample, irradiation mechanism, and detection mechanism in a three-dimensional manner, based on the data converted by the conversion portion and on the data stored in the storage portion. The decision portion makes a decision by a simulation in advance as to whether the sample will interfere with the irradiation mechanism and detection mechanism before the operator actually operates the stage to place the certain position on the sample into the measurement point. The decision portion makes a report of the result of the decision. As a result, as mentioned previously, the operator can forecast as to whether the sample will interfere with the irradiation mechanism and detection mechanism. The interference can be prevented.

Especially, unlike the prior art one, interference itself can be prevented. Therefore, components such as the irradiation mechanism and detection mechanism can be prevented from interfering with the sample; otherwise, the sample, irradiation mechanism, and detection mechanism would be deformed or damaged. Consequently, the burden on the operator can be reduced as much as possible. Cost necessary for maintenance can be reduced. Furthermore, the reliability of the apparatus can be enhanced.

Furthermore, the presence or absence of interference can be simulated in advance while assuming the case in which the sample is displaced into various states. Therefore, it is easy to use the apparatus. This leads to improvement of the working efficiency. In addition, unlike the prior art one, no limitations are imposed on the kind of the sample. From these reasons, too, it is easy to use the apparatus. The apparatus is excellent in terms of convenience.

As described previously, according to the charged particle beam apparatus associated with the present invention, interference with the sample is forecasted before the stage is operated irrespective of the kind of the sample, whereby the interference can be prevented. Furthermore, the burden on the operator can be reduced as much as possible.

Furthermore, the charged particle beam apparatus associated with the present invention is based on the above-described charged particle beam apparatus of the present invention and further characterized in that the conversion portion has a data acquisition portion for previously acquiring three-dimensional data about the sample by optically observing the sample.

The charged particle beam apparatus associated with this invention can acquire three-dimensional data about the sample by optical observing it with an optical microscope or the like if the three-dimensional data about the sample is not obtained in advance, because the apparatus is equipped with the data acquisition portion. Therefore, even an unknown sample about which three-dimensional data is not previously obtained can be used. This can widen the choice of samples.

Furthermore, the charged particle beam apparatus associated with the present invention is based on the above-described charged particle beam apparatus of the present invention and further characterized in that the decision portion displays the results of the simulation on the display portion as a three-dimensional image.

In the charged particle beam apparatus associated with this invention, the results of a simulation performed as to whether or not a sample has interfered can be displayed on the display portion as a virtual three-dimensional image. Therefore, the operator can grasp the degree of interference more precisely and at a glance. Furthermore, simulations can be performed while checking by three-dimensional images assuming various circumstances. Consequently, the efficiency of the work can be improved further.

In addition, the charged particle beam apparatus associated with the present invention is based on any one of the above-described charged particle beam apparatus of the present invention and further characterized in that when the decision means has determined that there will be interference, the stage is locked.

In the charged particle beam instrument associated with this invention, if the decision portion determines that an interference will be produced when a certain position on the sample is being brought into the measurement point or has been placed in the measurement point, the stage is locked. Consequently, there is no danger that the operator will erroneously operate the stage; otherwise, interference will be caused. Accordingly, the operator is permitted to do the work without anxiety. This can further reduce the burden on the operator.

In addition, the charged particle beam instrument associated with the present invention is based on any one of the above-described charged particle beam instruments of the present invention and further characterized in that the decision portion makes a report of the movable range of the stage in which it is displaceable immediately prior to interference.

In the charged particle beam instrument associated with this invention, the decision portion makes a report of the movable range of the stage in which it can be displaced immediately prior to interference and so the operator can operate the stage within the movable range without anxiety. Furthermore, the operator can reselect the next certain position that can be placed at the measurement point within the movable range. Consequently, the working efficiency can be improved.

In addition, the charged particle beam instrument associated with the present invention is based on any one of the above-described charged particle beam instruments of the present invention and further characterized in that the stage has: an XYZ moving mechanism for moving the sample table along X- and Y-axes parallel to a horizontal plane and perpendicular to each other and along a Z-axis perpendicular to the X- and Y-axes; a rotation mechanism for rotating the sample table about the Z-axis; and a tilt mechanism for rotating the sample table about the X- or Y-axis. When the decision portion has determined that there will be no interference, the decision portion makes a report of the orders of operations and operation times of the XYZ moving mechanism, the rotation mechanism, and the tilt mechanism such that the certain position on the sample is placed into the measurement point in the shortest time.

In the charged particle beam instrument associated with this invention, the stage is equipped with the XYZ moving mechanism, rotation mechanism, and tilt mechanism and so the sample table can be moved in the X-, Y-, and Z-axis directions, rotated about the Z-axis, and tilted about the X-axis or Y-axis. If the sample has a complex shape, the certain position can be placed into the measurement point reliably.

Furthermore, the decision portion calculates the orders of operations and operation times of the XYZ moving mechanism, rotation mechanism, and tilt mechanism to place the certain position on the sample into the measurement point in the shortest time and makes a report of them when the decision portion has determined that there will be no interference. Thus, the operator can place the certain position into the measurement point in the shortest time while preventing interference simply by operating the stage according to the report. Accordingly, the efficiency of the work can be enhanced further. In addition, the burden imposed during the work can be alleviated.

Additionally, the charged particle beam instrument associated with the present invention is based on any one of the above-described charged particle beam instruments of the present invention and further characterized in that the stage has: the XYZ moving mechanism for moving the sample table along X- and Y-axes parallel to a horizontal plane and perpendicular to each other and along a Z-axis perpendicular to the X- and Y-axes; the rotation mechanism for rotating the sample table about the Z-axis; and the tilt mechanism for rotating the sample table about the X- or Y-axis. When the decision portion has determined that there will be no interference, the decision portion operates the XYZ moving mechanism, the rotation mechanism, and the tilt mechanism to place the certain position on the sample into the measurement point in the shortest time.

In the charged particle beam instrument associated with this invention, the stage is equipped with the XYZ moving mechanism, rotation mechanism, and tilt mechanism and so the sample table can be moved in the X-, Y-, and Z-axis directions, rotated about the Z-axis, and tilted about the X-axis or Y-axis. Even if the sample has a complex shape, the certain position can be placed into the measurement point reliably.

When the decision portion has determined that there will be no interference, the decision portion appropriately operates the XYZ moving mechanism, rotation mechanism, and tilt mechanism to place the certain position on the sample into the measurement point in the shortest time automatically while preventing interference. Therefore, it is unnecessary for the operator to operate the stage manually. In addition, the certain position can be brought into the measurement point in the shortest time while preventing interference. Consequently, the efficiency of the work can be improved further. The burden imposed on the operator during the work can be suppressed to a minimum.

According to the charged particle beam instrument associated with the present invention, interference with the sample is forecasted before the stage is operated irrespective of the kind of the sample, thus preventing the interference. The burden on the operator can be reduced as much as possible.

### BRIEF DESCRIPTION OF THE DRAWINGS

FIG. 1 is a diagram showing one embodiment of a charged particle beam instrument associated with the present invention.

FIG. 2 is a diagram in which the contour lines of various components are displayed based on three-dimensional data about each component of the charged particle beam instrument shown in FIG. 1.

FIG. 3 is a diagram in which the contour lines of a sample are displayed based on three-dimensional data about the sample of the charged particle beam instrument shown in FIG. 1.

FIG. 4 is a diagram showing the state in which three or more points on a sample actually placed are irradiated with a charged particle beam and three-dimensional data about the sample is converted into a stage coordinate system.

FIG. 5 is a diagram showing an example of modification of the charged particle beam instrument shown in FIG. 1.

FIG. 6 is a view showing the state in which a sample is being measured by the prior-art charged particle beam instrument.

FIG. 7 is a view showing the manner in which the sample has interfered when the stage shown in FIG. 6 is operated.;

### DETAILED DESCRIPTION OF THE PREFERRED EMBODIMENTS

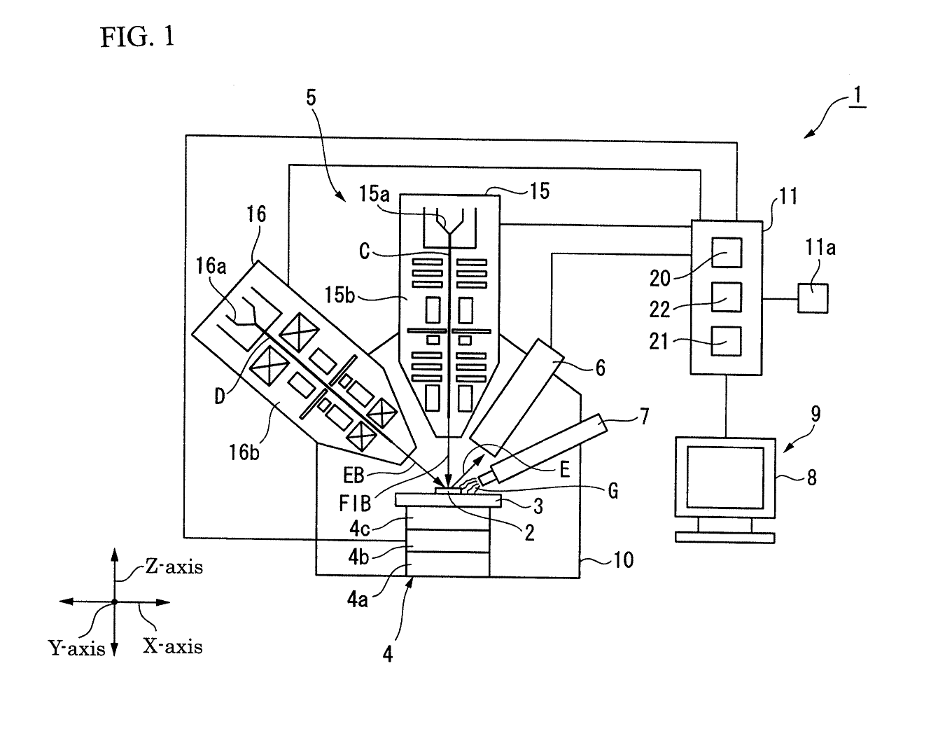

One embodiment of a charged particle beam instrument associated with the present invention is hereinafter described with reference to FIGS. 1 to 4. In the description of the present embodiment, charged particle beam instruments capable of emitting a focused ion beam (FIB) and an electron beam (EB), respectively, are taken as examples.

As shown in FIG. 1, the charged particle beam instrument 1 of the present embodiment has a sample table 3 on which a sample 2 is placed, a stage 4 for displacing the sample table 3, an irradiation mechanism 5 for irradiating the sample 2 with an FIB and an EB that are charged particle beams, a secondary charged particle detector (detection mechanism) 6 for detecting secondary charged particles E produced by the irradiation by the FIB and EB, a gas gun 7 for supplying a source gas G for depositing a film near the surface of the sample 2 irradiated with the FIB, and a display mechanism 9 having a display portion 8 for creating image data about the sample 2 based on the detected secondary charged particles E and displaying the image data as a sample image.

The sample 2 is received within a vacuum sample chamber 10. FIB irradiation, EB irradiation, and supply of the source gas G are carried out within the vacuum sample chamber 10.

The stage 4 operates under instructions from a control portion 11. In the present embodiment, the sample table 3 can be displaced on 5 axes. That is, the stage 4 is composed of an XYZ moving mechanism 4b for moving the sample table 3 along X- and Y-axes which are parallel to a horizontal plane and perpendicular to each other and along a Z-axis perpendicular to the X- and Y-axes, a rotation mechanism 4c for rotating the sample table 3 about the Z-axis, and a tilt mechanism 4a for rotating the sample table 3 about the X-axis (or Y-axis).

The stage 4 constructed in this way can place a certain position on the sample 2 into a measurement point hit by the FIB and EB by displacing the sample table 3 on the 5 axes.

The irradiation mechanism 5 is composed of an FIB microscope column 15 for irradiating the sample 2 placed in the measurement point with the FIB and an SEM microscope column 16 for emitting the EB. The FIB microscope column 15 has an ion-generating source 15a and an ion optical system 15b. After finely focusing ions C produced by the ion-generating source 15a by the ion optical system 15b into an FIB, the FIB is directed at the sample 2. The SEM microscope column 16 has an electron-generating source 16a and an electron optical system 16b. After electrons D produced by the electron-generating source 16a are finely focused by the electron optical system 16b to form an electron beam EB, the beam is directed at the sample.

The control portion 11 provides an overall control of the above-described components. The control portion also converts secondary charged particles E detected by the secondary charged particle detector 6 into a brightness signal and creates image data and then outputs them to the display portion 8. Thus, the display portion 8 can display a sample image as described above. That is, the control portion 11 and display portion 8 together constitute the display mechanism 9.

An input portion 11a through which an operator can make an input is connected with the control portion 11. The various components are controlled based on a signal entered by the input portion 11a. That is, the operator can displace the sample table 3 and sample 2 by operating the stage 4 and can control the timings of FIB and EB irradiations and the timing at which the source gas G is supplied.

Furthermore, in the charged particle beam instrument 1 of the present embodiment, a storage portion 20, a conversion portion 21, and a decision portion 22 are provided within the control portion 11. Three-dimensional data about various components disposed above the sample 2, i.e., the FIB microscope column 15, SEM microscope column 16, secondary charged particle detector 6, and gas gun 7, are previously stored in the storage portion 20 while interrelated to a stage coordinate system W.

The conversion portion 21 has previously entered three-dimensional data about the sample 2, and converts the three-dimensional data about the sample 2 into the stage coordinate system W based on the posture and placement position of the placed sample 2. These storage portion 20 and conversion portion 21 will be described in detail later.

The decision portion 22 simulates the positional relationship between the sample 2 and each component, based on the three-dimensional data about the sample 2 converted by the conversion portion 21 and on three-dimensional data about each component stored in the storage portion 20 when the stage 4 is operated to place the certain position on the sample 2 into the measurement point, and makes a decision in advance as to whether the sample 2 will interfere. The decision portion informs the operator of the result of the decision. For example, the decision portion displays the result of the decision on the display portion 8 or makes a report by speech sound.

A case in which the sample 2 is observed by the charged particle beam instrument 1 constructed in this way is next described.

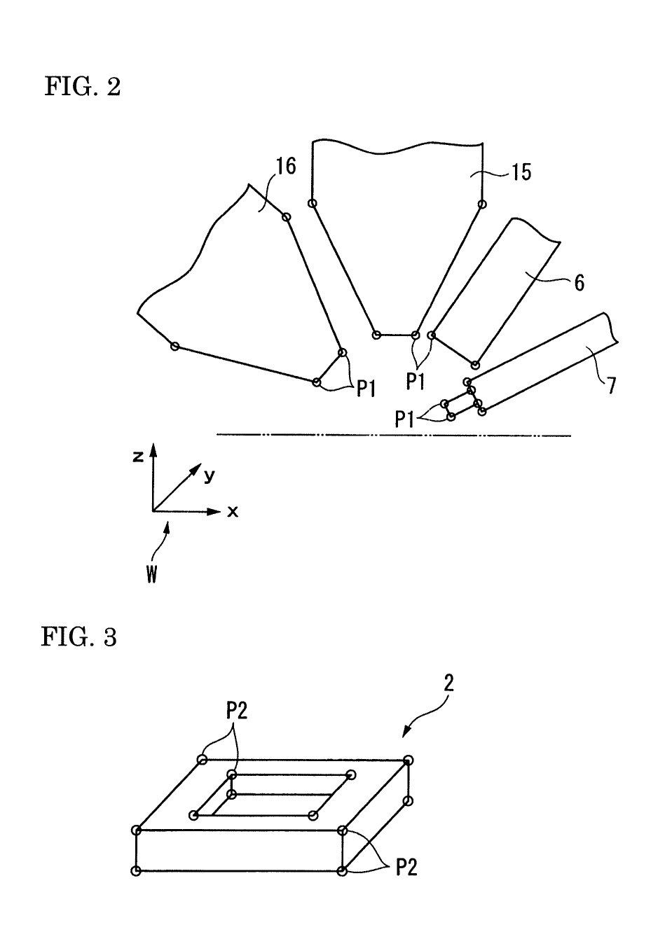

First, as mentioned previously, three-dimensional data about each component disposed on the stage 4 are previously stored in the storage portion 20 while interrelated to the stage coordinate system W. That is, according to the data stored in the storage portion 20, the three-dimensional contour line of each component can be grasped precisely as shown in FIG. 2. It is also possible to precisely grasp at what position each component is located in the stage coordinate system W. P1 shown in FIG. 2 are points whose three-dimensional coordinates have been found. Three-dimensional data are composed by these plural points P1.

Similarly, three-dimensional data about the sample 2 that is an object to be measured have been previously entered in the conversion portion 21 and so it is possible to precisely grasp the three-dimensional contour line of the sample 2 irrespective of how complex is the shape of the sample 2 as shown in FIG. 3. P2 shown in FIG. 3 are points whose three-dimensional coordinates have been found in the same way as P1 shown in FIG. 2. Three-dimensional data are built by these plural points P2. Furthermore, in the present embodiment, the sample 2 which is centrally provided with a step portion and which is relatively uneven is taken as an example.

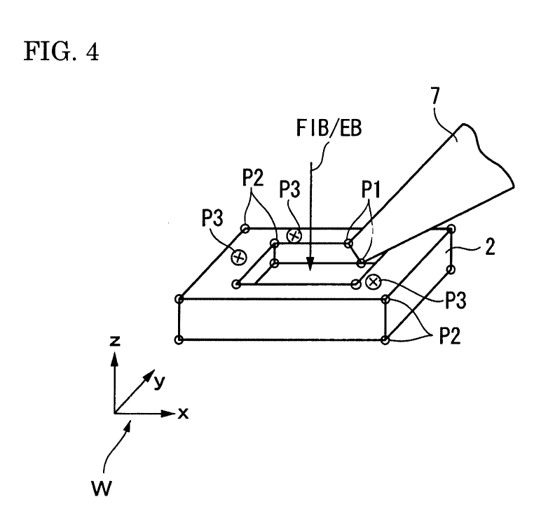

First, the operator places the sample 2 that is an object to be measured onto the sample table 3. Then, the conversion portion 21 is made to perform converting processing for converting the three-dimensional data about the sample 2 into the stage coordinate system W. For this purpose, it is necessary to know what posture does the sample 2 assume on the sample table 3 and at what position is the sample placed. Accordingly, as shown in FIG. 4, at least three points (alignment points) P3 on the surface of the sample 2 are irradiated with the FIB or EB, and coordinate data about the stage coordinate system W of these points P3 are checked from the sample image. In FIG. 4, to simplify the illustration, the gas gun 7 is shown as a representative of the components.

On the other hand, coordinate data about each point P3 is already known from the coordinate system of the three-dimensional data about the sample 2. Therefore, the converting processing can be performed while correcting the scale by comparing both sets of coordinate data. Because measurements are performed at three or more points P3, tilt correction can also be made. As a result, the three-dimensional data about the sample 2 can be linked to the stage coordinate system W. The manner in which the sample 2 is placed on the stage 4 actually can be precisely recognized as three-dimensional data. That is, the points P2 shown in FIG. 3 can be represented by the stage coordinate system W.

Therefore, the decision portion 22 can precisely grasp the relative positional relationship between the sample 2 and each component in a three-dimensional manner, based on data converted by the conversion portion 21 and on data stored in the storage portion 20. Accordingly, the operator causes the decision portion 22 to simulate the presence or absence of interference before the stage 4 is actually operated to place the certain position on the sample 2 into the measurement point. On receiving this, the decision portion 22 simulationally judges a halfway route assumed until the certain position on the sample 2 is placed into the measurement point. Furthermore, the decision portion simulationally makes a decision as to whether the sample 2 will interfere with each component when the certain position has been brought to the measurement point. In addition, the decision portion informs the operator to that effect. As a result, the operator can forecast as to whether or not the sample 2 will interfere before the stage 4 is actually operated. The interference can be prevented.

Where the operator is informed that there will be no interference, the operator operates the stage 4 via the input portion 11a to actually displace the sample table 3 and sample 2. That is, the stage 4 places the certain position on the sample 2 into the measurement point by appropriately moving the stage in the 3 directions of X-, Y-, and Z-axes, rotating the stage about the Z-axis, or tilting the stage about the X-axis (or Y-axis). Subsequently, FIB or EB is made to hit the certain position by the FIB microscope column 15 or SEM microscope column 16. The secondary charged particle beam detector 6 detects secondary charged particles E produced by FIB or EB irradiation, and makes an output to the control portion 11. The control portion 11 creates image data from the secondary charged particles E sent in, and outputs the data to the display portion 8. The display portion 8 displays the image data as a sample image. As a result, the operator can observe the certain position on the sample 2.

Especially, the stage 4 of the present embodiment can displace the sample table 3 along the five axes by means of the XYZ moving mechanism 4b, rotation mechanism 4c, and tilt mechanism 4a. Therefore, even if the sample 2 has a complex shape, the certain position can be placed into the measurement point reliably.

Furthermore, in the present embodiment, a modification of the certain position is enabled as well as observation. For example, the certain position can be modified by etching it by FIB irradiation. A modification may also be made by depositing a film by a gas-assisted method relying on FIB irradiation and supply of source gas G.

Especially, interference itself can be prevented unlike the prior art one. Therefore, it is unlikely that the sample 2 or each component is deformed or damaged due to interference. Consequently, the burden placed on the operator can be reduced as much as possible. The cost necessary for maintenance can be reduced. Furthermore, the reliability of the instrument can be enhanced.

In addition, the presence or absence of interference can be simulated in advance assuming the case where the stage 4 is displaced to various states. Therefore, it is easy to use, which can lead to improvement of the efficiency of the work. Furthermore, unlike the prior art one, no limitations are imposed on the kind of the sample 2. Also in this respect, the instrument is easy to use. It is excellent in terms of convenience.

As described above, according to the charged particle beam instrument 1 of the present embodiment, interference with the sample 2 can be prevented by forecasting the interference before the stage 4 is operated irrespective of the kind of the sample 2. The burden on the operator can be reduced as much as possible.

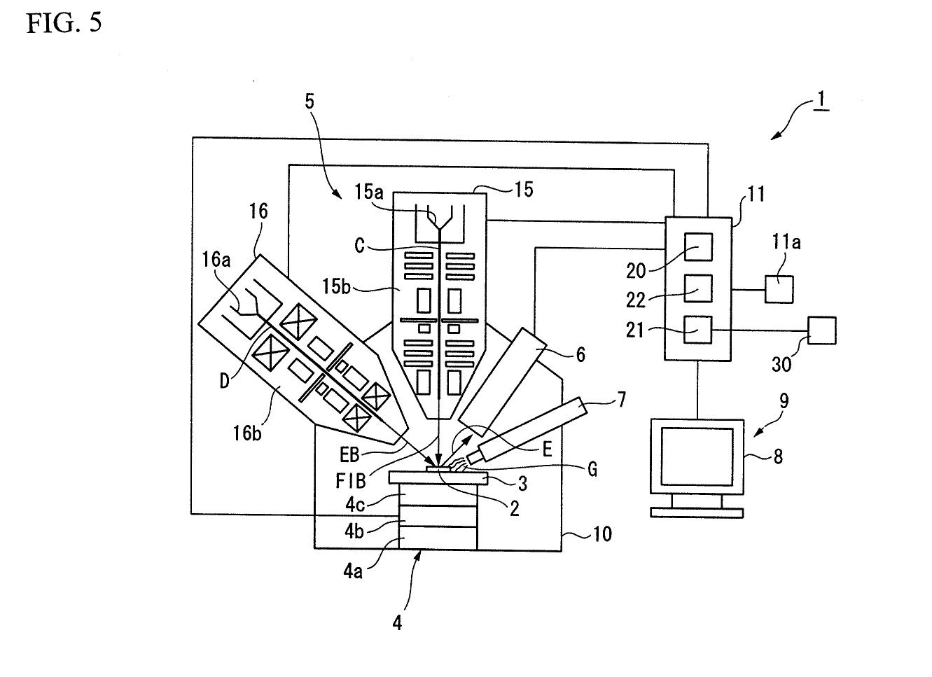

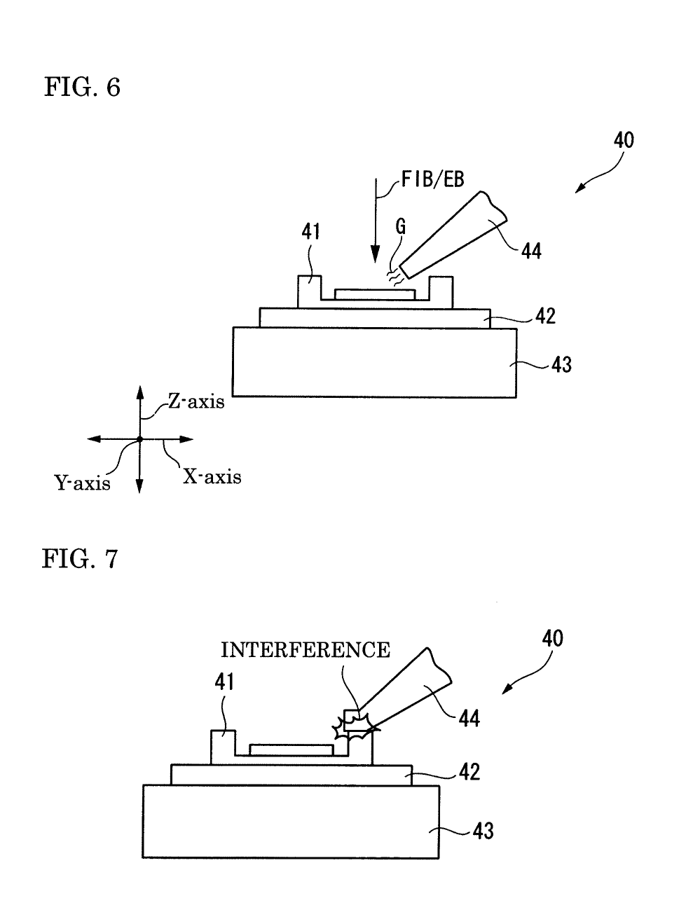

In the above embodiment, a case in which three-dimensional data about the sample 2 is previously entered into the conversion portion 21 is taken as an example. For example, as shown in FIG. 5, the data acquisition portion 30 for optically observing the sample 2 and obtaining three-dimensional data about the sample 2 may be connected with the conversion portion 21. A digital microscope or the like capable of making three-dimensional observations, measuring three-dimensional shapes, and so on can be used as the data acquisition portion 30, for example. This permits the sample 2 to be optically observed and three-dimensional data about the sample 2 can be acquired if the data is not available beforehand. Consequently, even an unknown sample 2 about which no three-dimensional data has been obtained beforehand can be used. The width of choice of the sample 2 can be widened.

Furthermore, the decision portion 22 may be designed such that the result of a simulated decision is displayed as a three-dimensional image on the display portion 8. Thus, the result of a simulation as to whether or not the sample 2 has interfered can be displayed as a virtual three-dimensional image on the display portion 8. Therefore, the operator can grasp the degree of interference more precisely and at a glance. Furthermore, a simulation can be performed while making a check with a three-dimensional image assuming various circumstances. Consequently, the efficiency of the work can be enhanced further.

When the decision portion 22 may be so designed that when it has determined that there will be interference, the stage 4 is locked. Thus, when the certain position on the sample 2 is being brought into the measurement point or has been placed in the measurement point, the stage 4 can be locked if the decision portion has determined that there will be interference and so there is no danger that the operator erroneously operates the stage 4, inducing interference. Therefore, it is possible to make the operator work with ease. The burden placed on the operator can be alleviated further.

Furthermore, the decision portion 22 may be so designed that the decision portion 22 makes a report of the movable range of the stage 4 that can be displaced immediately before interference. This permits the operator to grasp the movable range of the stage 4 capable of being displaced immediately before interference takes place. Therefore, the stage 4 can be operated within this movable range with ease. Furthermore, the operator can reselect the next certain position that can be placed into the measurement point within the movable range. Consequently, the efficiency of the work can be improved further.

The instrument may be so designed that when the decision portion 22 has determined that there will be no interference, the decision portion 22 makes a report of orders of operations and operation times of the XYZ moving mechanism 4b, the rotation mechanism 4c, and tilt mechanism 4a to place the certain position on the sample 2 into a measurement point in the shortest time. Thus, the operator can place a certain position into the measurement point in the shortest time while preventing interference simply by operating the stage 4 according to the report. Accordingly, the efficiency of the work can be improved further. The burden placed during work can be alleviated further.

Furthermore, the instrument may be so designed that when the decision portion 22 has determined that there will be no interference, a certain position on the sample 2 is placed into a measurement point in the shortest time by operating the XYZ moving mechanism 4b, rotation mechanism 4c, and tilt mechanism 4a. This makes it unnecessary for the operator to manually operate the stage 4. In addition, the certain position on the sample 2 can be automatically placed into the measurement point in the shortest time while preventing interference. Accordingly, the efficiency of work can be enhanced further. The burden placed on the operator during work can be suppressed to a minimum.

It is to be noted that the technical scope of the present invention is not limited to the above-described embodiment but rather various changes and modifications can be made without departing from the scope of the gist of the present invention.

For example, in the above embodiment, a case in which there is provided the irradiation mechanism 5 having both FIB microscope column 15 emitting FIB and SEM microscope column 16 emitting EB is taken as an example. It may suffice to be capable of only one of FIB irradiation and EB irradiation. Furthermore, a case in which there is provided the gas gun 7 is taken as an example. It is also possible that the gas gun 7 is not fitted.

1. A charged particle beam apparatus comprising:
a sample table on which a sample is placed;
a stage for displacing the sample table to bring a certain position of the sample into a measurement point;
an irradiation mechanism for irradiating the certain point of the sample with a charged particle beam;
a detection mechanism for detecting secondary charged particles produced by the irradiation of the charged particle beam;
a display mechanism for creating image data about the sample based on the detected secondary charged particles, the display mechanism having a display portion for displaying the image data as a sample image;
a storage portion for previously storing three-dimensional data about the irradiation mechanism and about the detection mechanism such that the three-dimensional data are interrelated with a stage coordinate system for the stage;
a conversion portion for converting previously entered three-dimensional data about the sample into the stage coordinate system based on a posture and a position of the placed sample; and
a decision portion for making a decision in advance as to whether the sample will interfere by making a simulation of positional relationships among the sample, the irradiation mechanism, and the detection mechanism based on data converted by the conversion portion and on data stored in the storage portion when the certain position of the sample is brought into the measurement point, the decision portion also reporting results of the decision.

2. A charged particle beam apparatus according to claim 1, wherein said conversion portion is equipped with a data acquisition portion for optically observing the sample and previously acquiring the three-dimensional data about the sample.

3. A charged particle beam apparatus according to claim 1, wherein said decision portion displays results of the simulation as a three-dimensional image on said display portion.

4. A charged particle beam apparatus according to claim 1, wherein said decision portion locks said stage when the decision portion has judged that there will be interference.

5. A charged particle beam apparatus according to claim 1, wherein said decision portion makes a report of a movable range of the stage in which it is displaceable immediately before interference takes place.

6. A charged particle beam apparatus according to claim 1,
wherein said stage has an XYZ moving mechanism (i) for moving the sample table along X- and Y-axes which are parallel to a horizontal plane and perpendicular to each other and along a Z-axis perpendicular to the X- and Y-axes, (ii) a rotation mechanism for rotating the sample table about the Z-axis, and (iii) a tilt mechanism for rotating the sample table about the X-axis or Y-axis, and
wherein said decision portion makes a report of orders of operations and operation times of the XYZ moving mechanism, the rotation mechanism, and tilt mechanism to place the certain position on the sample into said measurement point in the shortest time when said decision portion has determined that there will be no interference.

7. A charged particle beam apparatus according to claim 1,
wherein said stage has an XYZ moving mechanism (i) for moving the sample table along X- and Y-axes which are parallel to a horizontal plane and perpendicular to each other and along a Z-axis perpendicular to the X- and Y-axes, (ii) a rotation mechanism for rotating the sample table about the Z-axis, and (iii) a tilt mechanism for rotating the sample table about the X-axis or Y-axis, and
wherein said decision portion operates the XYZ moving mechanism, the rotation mechanism, and the tilt mechanism to place the certain position on the sample into said measurement point in the shortest time when the decision portion has determined that there will be no interference.
